(19) United States
(12) Patent Application Publication
(10) Pub. No.: US 2025/0315191 A1
(43) Pub. Date: Oct. 9, 2025

(54) READ STREAMING

(71) Applicant: Samsung Electronics Co., Ltd., Suwon-si (KR)

(72) Inventor: Marc Timothy JONES, Longmont, CO (US)

(21) Appl. No.: 18/925,003

(22) Filed: Oct. 23, 2024

Related U.S. Application Data
(60) Provisional application No. 63/631,789, filed on Apr. 9, 2024.

(51) Int. Cl. G06F 3/06

(52) U.S. Cl. CPC G06F 3/0659; G06F 3/0613; G06F 3/0656; G06F 3/0679

(57) ABSTRACT

A system is disclosed. The system may include a processor, a device, and a memory accessible to the processor and to the device. The memory may include a queue including an entry and a buffer. The entry may identify the buffer. The processor may place a request in the entry of the queue and the device is may process the request using the buffer.

### RELATED APPLICATION DATA

This application claims the benefit of U.S. Provisional Patent Application Ser. No. 63/631,789, filed Apr. 9, 2024, which is incorporated by reference herein for all purposes.

### FIELD

The disclosure relates generally to storage, and more particularly to streaming data from storage devices.

### BACKGROUND

Reading data from a storage device involves sending a request from a processor to the storage device. The storage device accesses the request, determines where the data is stored, accesses the data, and returns the data to the processor. There are many opportunities for latency to cause delay, slowing down the overall performance of the read request.

A need remains to improve how read requests are handled.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including a storage device that may perform streaming operations, according to embodiments of the disclosure.

FIG. 2 shows details of the machine of FIG. 1, according to embodiments of the disclosure.

FIG. 3 shows how the storage device of FIG. 1 may use a ring buffer for streaming operations, according to embodiments of the disclosure.

FIG. 4 shows details of an entry of FIG. 3, according to embodiments of the disclosure.

FIG. 5 shows how namespaces may be used in the storage device of FIG. 1, according to embodiments of the disclosure.

FIG. 6 shows details of the storage device of FIG. 1, according to embodiments of the disclosure.

FIG. 7 shows a flowchart of an example procedure for the processor of FIG. 1 to use the ring buffer of FIG. 3, according to embodiments of the disclosure.

FIG. 8 shows a flowchart of an example procedure for the processor of FIG. 1 to place a request in the entry of FIG. 3, according to embodiments of the disclosure.

FIG. 9 shows a flowchart of an example procedure for the processor of FIG. 1 to retrieve a result from the entry of FIG. 3, according to embodiments of the disclosure.

FIG. 10 shows a flowchart of an example procedure for the processor of FIG. 1 to allocate the ring buffer of FIG. 3 and the buffers of FIG. 4, according to embodiments of the disclosure.

FIG. 11 shows a flowchart of an example procedure for the processor of FIG. 1 to deallocate the ring buffer of FIG. 3 and the buffers of FIG. 4, according to embodiments of the disclosure.

FIG. 12 shows a flowchart of an example procedure for the processor of FIG. 1 to notify the storage device of FIG. 1 about an interval for using the ring buffer of FIG. 3, according to embodiments of the disclosure.

FIG. 13 shows a flowchart of an example procedure for the storage device of FIG. 1 to use the ring buffer of FIG. 3, according to embodiments of the disclosure.

FIG. 14 shows a flowchart of an example procedure for the storage device of FIG. 1 to return a result to the processor of FIG. 1 using the ring buffer of FIG. 3, according to embodiments of the disclosure.

FIG. 15 shows a flowchart of an example procedure for the storage device of FIG. 1 to determine the address of the buffer of FIG. 4, according to embodiments of the disclosure.

FIG. 16 shows a flowchart of an example procedure for the storage device of FIG. 1 to process a request from the ring buffer of FIG. 3, according to embodiments of the disclosure.

FIG. 17 shows a flowchart of an example procedure for the storage device of FIG. 1 to use the ring buffer of FIG. 3 with an interval, according to embodiments of the disclosure.

### SUMMARY

A processor and a device may use a queue, such as a ring buffer, to exchange requests and results. The processor may place requests in the queue, and the device may process and return results using the queue.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

To read data from a storage device, a processor sends a read request to the storage device. The read request includes an opcode (indicating that the request is a read request), identifies the data to be read, and where the data is to be stored after it is read from the storage device (the read request may also include other data as well relevant to the read request). The storage device may then interpret the request to identify that it is a read request, locate the data on the storage device, access the data, and write the data to where it is to be stored.

This approach works well enough for individual read requests. But there are various opportunities for latency to occur. For example, other requests might be queued up ahead of the read request, or the storage device might be interrupted to process a request from another host (for example, another virtual machine running on the processor).

While the occasional slow response to a read request might not be problematic among individual unrelated read requests, added latency may be a concern where data is being streamed. For example, when streaming large amounts of data, such as audio or video content, an unusually long latency for a particular read request might result in a pause in the presentation of the data to a user. No user enjoys experiencing such buffering delays, and therefore such delays are to be avoided, if possible.

Embodiments of the disclosure address these concerns by introducing to the storage device support for read streaming. The processor may define a queue, such as a ring buffer, and various buffers somewhere accessible to both the host and the storage device. The processor may inform the storage device about the locations of the queue and the buffers. The processor may then place requests in the queue for data to be read from the storage device, indicating in which buffer the data should be stored. This approach may bypass the use of the submission queue/completion queue approach for submitting commands to the storage device, which has the opportunity to introduce additional or unexpected latencies.

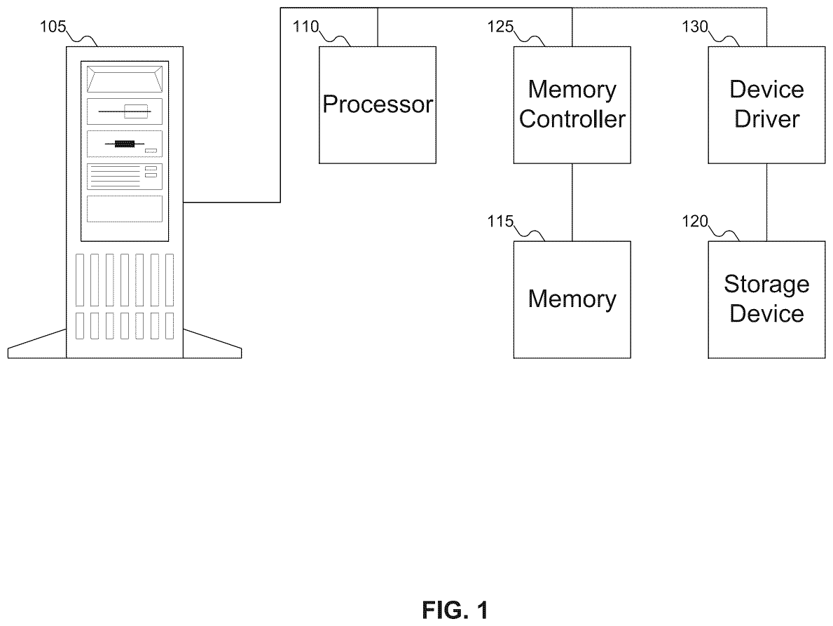

FIG. 1 shows a machine including a storage device that may perform streaming operations, according to embodiments of the disclosure. In FIG. 1, machine 105, which may also be termed a host or a system, may include processor 110, memory 115, and storage device 120.

Processor 110, which may also be referred to as a host processor, may be any variety of processor. (Processor 110, along with the other components discussed below, are shown outside the machine for ease of illustration: embodiments of the disclosure may include these components within the machine.) While FIG. 1 shows a single processor 110, machine 105 may include any number (one or more, without bound) of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. Whereas memory 115 may be used to store data that is considered “short-term”, storage device 120, which may also be termed a memory device, may be used to store data that is considered “long-term”: that is, data that is expected to be retained for longer periods of time and that should be retained in a persistent manner, even if deliver of power to machine 105 should be interrupted. Storage device 120 may be accessed using device driver 130.

Storage device 120 may be associated with an accelerator. Such an accelerator may be used for, for example, near-data processing. That is, the accelerator may be used to process data closer to storage device 120, to reduce or eliminate transfer of data from storage device 120 into memory 115. The use of an accelerator for near-data processing may also offload processing from processor 110, as the accelerator may perform such processing instead of processor 110. Like processor 105, such an accelerator may implement a Reduced Instruction Set Computer (RISC) architecture or a Complex Instruction Set Computer (CISC) architecture (among other possibilities), and may be implemented using a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

The combination of storage device 120 and accelerator may also be referred to as a computational storage device, computational storage unit, computational storage device, or computational device. Storage device 120 and an accelerator may be designed and manufactured as a single integrated unit, or the accelerator may be separate from storage device 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage device 120 may be understood to refer to both storage device 120 and the accelerator either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or the accelerator might not be able to communicate with another storage device. For example, the storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). Any reference to a specific type of storage device, such as an “SSD”, below should be understood to include such other embodiments of the disclosure.

Processor 105 and storage device 120 may communicate across a fabric (not shown in FIG. 1). This fabric may be any fabric along which information may be passed. Such fabrics may include fabrics that may be internal to machine 105, and which may use interfaces such as Peripheral Component Interconnect Express (PCIe), Serial AT Attachment (SATA), or Small Computer Systems Interface (SCSI), among others. Such fabrics may also include fabrics that may be external to machine 105, and which may use interfaces such as Ethernet, Infiniband, or Fibre Channel, among others. In addition, such fabrics may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, such fabrics may be thought of as encompassing both internal and external networking connections, over which commands may be sent, either directly or indirectly, to storage device 120. In embodiments of the disclosure where such fabrics support external networking connections, storage device 120 might be located external to machine 105, and storage device 120 might receive requests from a processor remote from machine 105.

Storage device 120 is an example of a device with which processor 110 may perform streaming. But other devices may also support streaming services. For example, processor 110 might perform streaming using a network interface card of machine 105. While embodiments of the disclosure are described with reference to storage device 120 as performing streaming operations, embodiments of the disclosure may also include any other type of device for streaming purposes. Any reference to “storage device” below should be understood as also extending to other types of devices, whether or not explicitly discussed.

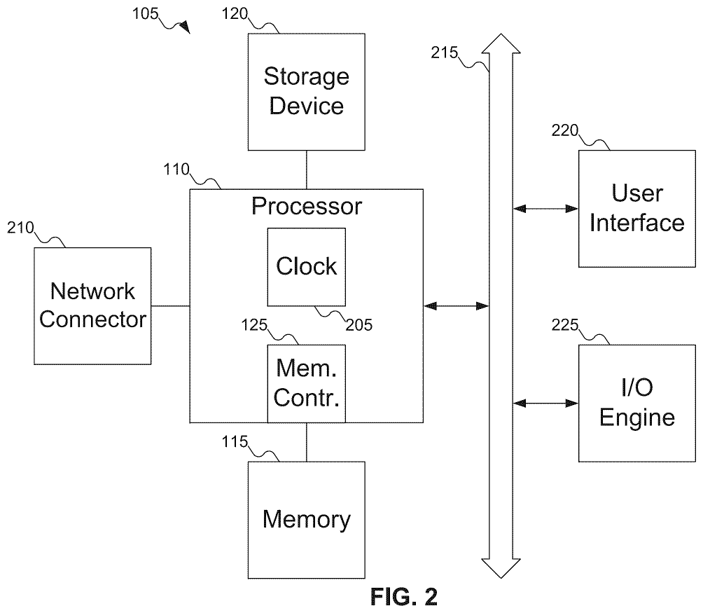

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

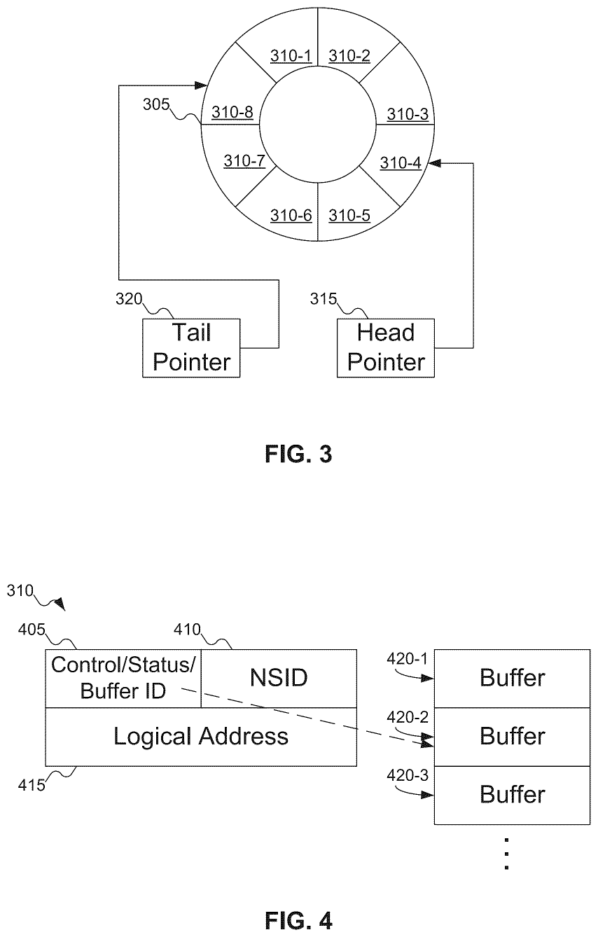

FIG. 3 shows how storage device 120 of FIG. 1 may use a ring buffer for streaming operations, according to embodiments of the disclosure. In FIG. 3, ring buffer 305 is shown. Ring buffer 305 may be a queue that is circular: the “last” entry in ring buffer 305 is followed by the “first” entry in ring buffer 305. Using ring buffer 305, there may be no concern about going past “the end” of buffer 305. Ring buffer 305 is shown as including eight entries 310-1 through 310-8 (which may be referred to collectively as entries 310 or slots 310).

Ring buffer 305 may be implemented, for example, as an array of addresses in memory. If the base address of ring buffer 305 is b, each entry 310 has a size e, and the total number of entries 310 in ring buffer 305 is n, then the address of the i^{th} entry 405 in the ring buffer may be calculated as aᵢ=b+((i−1)*e) (this assumes that the first entry 405 is called entry 405 one: if entries 405 are counted starting at zero, then (i−1) may be replaced with i in the above equation). More importantly, given the address for entry 405 i (which may be referred to as aᵢ), the address for the next entry 405 in the ring buffer (which would be the first entry if the current entry is the last entry in the ring buffer) may be calculated as aᵢ₊₁=((aᵢ+e−b)%(n*e))+b, where % is the modulo operator. Using this equation, processor 120 of FIG. 1 and storage device 120 of FIG. 1 do not need to determine which entry 310 was last used and check to see if that entry 405 is the “last” entry 310 in the ring buffer: processor 120 of FIG. 1 and storage device 120 of FIG. 1 may calculate the address for the next entry 310, with wrapping around from the “last” entry 310 to the “first” entry 310 happening automatically.

It is also possible to calculate the address of entry 310 in ring buffer 305 for the k^{th} request written to ring buffer 305. Again, if the base address of ring buffer 305 is b, each entry 310 has a size e, and the total number of entries 310 in ring buffer 305 is n, then the address where the kth request may be written to ring buffer 305 may be calculated as aₖ=b+((k−1)%n)*e (again assuming that counting requests starts at one).

Note that these last two equations assume that requests are always added to and removed from ring buffer 305 in the same order, without creating any gaps in the sequence. In embodiments of the disclosure where requests may be removed from ring buffer 305 out of order, the addresses of entries 310 determined by these equations might not be “open” to store a new request, in which case ring buffer 305 may be searched for the next open entry 310.

Ring buffer 305 may also include two additional pointers. Head pointer 315 may track the entry that is at the “head” of the line in ring buffer 305 (that is, entry 310 that was placed in ring buffer 305 first). Head pointer 315 may identify slot 310 in ring buffer 305 that is to be inserted into by processor 110 of FIG. 1. Put another way, head pointer 315 identifies the newest occupied slot 310 in ring buffer 305. Tail pointer 320 may track the entry that is at the “tail” of the line in ring buffer 305 (that is, entry 310 that was placed in ring buffer 305 last). Tail pointer 320 may identify slot 310 in ring buffer 305 from which storage device 120 of FIG. 1 should remove the next request for processing. Put another way, tail pointer 320 identifies the oldest occupied slot 310 in ring buffer 305.

Processor 110 of FIG. 1 may use head pointer 315 to determine entry 310 into which the next request may be placed in ring buffer 305, and storage device 120 of FIG. 1 may use tail pointer 320 to determine which entry 310 stores the next request to be processed. Note that the terminology may be interchanged or replaced, depending on the implementation. The names for pointers 315 and 320 is less important than how they are used.

Storage device 120 of FIG. 1 may consume requests from slots 310 from the tail, updating their status. Once processor 110 of FIG. 1 determines that slot 310 that was pointed to by tail pointer 320 was processed by storage device 120 of FIG. 1 and is complete, processor 110 of FIG. 1 may consume the data placed in that entry 310 and may increment tail pointer 320 (to point to the next entry 310 in rung buffer 305). By incrementing tail pointer 320, an old entry 310 is now usable by processor 110. If tail pointer 320 then points to a slot that stores another request from processor 110 of FIG. 1 (which may be determined by comparing tail pointer 320 with head pointer 315: if tail pointer 320 and head pointer 315 point to the same entry 310, then ring buffer 305 is empty), then storage device 120 of FIG. 1 may continue processing requests from entries 310 in ring buffer 305.

Processor 110 of FIG. 1 may notify storage device 120 of FIG. 1 that a request has been placed in entry 310 of ring buffer 305 by using a notification mechanism, such as a doorbell. By ringing a doorbell, storage device 120 of FIG. 1 may be informed that there has been an update to ring buffer 305 for storage device 120 of FIG. 1 to handle. Storage device 120 of FIG. 1 may then identify the request to be handled (using, for example, tail pointer 320) and may then process the request. In a similar manner, storage device 120 of FIG. 1 may notify processor 110 of FIG. 1 that a request in ring buffer 305 has been processed in any desired manner: for example, using an interrupt, such as a Message Signaled Interrupt (MSI) or an extended MSI (MSI-X), to alert processor 110 of FIG. 1 to the presence of a response to a request in entry 310 of ring buffer 305.

In some embodiments of the disclosure, storage device 120 of FIG. 1 may access entries 310 of ring buffer 305, to access the requests in entries 310 of ring buffer 305. Storage device 120 may also update entries 310 of ring buffer 305 to store information relating to a response to a request. For example, consider entry 310-1, and assume that processor 110 of FIG. 1 has placed a read request in entry 310-1: that is, entry 310-1 includes a request for storage device 120 of FIG. 1 to read some data from storage device 120. Storage device 120 may access the request from entry 310-1, and may update entry 310-1 to reflect the completion of processing of the request.

Both processor 110 of FIG. 1 and storage device 120 of FIG. 1 may access head pointer 315 and tail pointer 320. That is, processor 110 of FIG. 1 may access head pointer 315 to update head pointer 315 to reflect the placement of a new request in entries 310 of ring buffer 305. Processor 110 of FIG. 1 may also update tail pointer 320 to reflect that the response in entries 310 of ring buffer 305 have been received and consumed by processor 110 of FIG. 1 (freeing entry 310 of ring buffer 305 for reuse). Storage device 120 of FIG. 1 may also access head pointer 315 and tail pointer 320 to locate entries 310 of ring buffer 305 still awaiting processing (tail pointer 320 identifying entry 310 of ring buffer 305 containing the oldest pending request, and head pointer 315 identifying entry 310 of ring buffer with the newest pending request). In some embodiments of the disclosure, only processor 110 of FIG. 1 may update head pointer 315 and tail pointer 320. As storage device 120 of FIG. 1 only accesses the requests in entries 310 of ring buffer 305 and updates entries 310 of ring buffer 305 as requests as processed, storage device 120 of FIG. 1 may not need to update either head pointer 315 or tail pointer 320. But in other embodiments of the disclosure, storage device 120 of FIG. 1 may also update either head pointer 315 or tail pointer 320 as appropriate. For example, if a particular request does not require any response be delivered to processor 110 of FIG. 1, storage device 120 of FIG. 1 may simply free entry 310 of ring buffer 305, and may update head pointer 315 or tail pointer 320 accordingly. Note that if both processor 110 of FIG. 1 and storage device 120 of FIG. 1 may update head pointer 315 and/or tail pointer 320, then it may be important to use locks, to prevent simultaneous access by processor 110 of FIG. 1 and storage device 120 of FIG. 1 (which could result in ring buffer 305 ending in an inconsistent state). Also, if storage device 120 of FIG. 1 may use ring buffer 305 to send a request to processor 110 of FIG. 1 (two-way communication, rather than just one-way communication with requests always originating from processor 110 of FIG. 1), then storage device 120 of FIG. 1 may update head pointer 315 and/or tail pointer 320 to reflect the request from storage device 120 of FIG. 1.

The above discussion implies that head pointer 315 is updated every time a request is placed in entries 310 of ring buffer 305, and that tail pointer 315 is updated every time a response is accessed from entries 310 of ring buffer 305. But in some embodiments of the disclosure, two or more requests may be placed in entries 310 of ring buffer 305, and head pointer 315 may be updated once to reflect the addition of both requests. Similarly, in some embodiments of the disclosure, two or more responses may be accessed from entries 310 of ring buffer 305, and tail pointer 320 may be updated to reflect the removal of both responses.

Processor 110 of FIG. 1 and storage device 120 of FIG. 1 may determine whether ring buffer 305 is empty (no entries 310 of ring buffer 305 storing a pending request) or full (all entries 310 of ring buffer 305 storing a pending request) by comparing head pointer 315 and tail pointer 320. For example, assume that head pointer 315 points to the next entry 310 of ring buffer 305 into which a request may be placed (that is, the entry 310 of ring buffer 305 that should store the next request), and that tail pointer 320 points to the next entry of ring buffer 305 from which a request should be processed (that is, the entry 310 of ring buffer 305 storing the oldest pending request). If head pointer 315 and tail pointer 320 are equal (mathematically, if head pointer=tail pointer), then ring buffer 305 is empty. On the other hand, if head pointer 315 points to the next entry 310 after tail pointer 320 (mathematically, head pointer=(tail pointer+1) modulo the number of entries), then ring buffer 305 is full. In other embodiments of the disclosure, head pointer 315 and/or tail pointer 320 may be used differently, with corresponding changes to the comparisons to determine whether ring buffer 305 is empty or full.

Note that the above description for ring buffer 305 implies that requests are added to entries 310 of ring buffer 305 in order, and are similarly processed in order. In some embodiments of the disclosure, this implementation is intentional. But other embodiments of the disclosure may support processing a request from any entry 310 from ring buffer 305, not just entry 310 pointed to by head pointer 315. For example, as noted above and discussed with reference to FIG. 4 below, entries 310 of ring buffer 305 may include a status field, which may indicate whether or not that entry 310 of ring buffer 305 has been processed. Tail pointer 320 may be arranged to always point to the oldest entry 310 of ring buffer 305 that contains a request waiting for processing. Thus, when entry 310 in ring buffer 305 pointed to by tail pointer 320 is freed (for example, after processor 110 of FIG. 1 has retrieved a response after storage device 120 of FIG. 1 has processed the request), tail pointer 320 may be moved to the next entry 310 of ring buffer 305 that is waiting processing: this entry 310 may be any number of entries 310 further along ring buffer 305, rather than the next entry 310 of ring buffer 305. Similarly, after a request is added to entry 310 of ring buffer 305 pointed to by head pointer 315, head pointer 315 may be updated to point to the next entry 310 of ring buffer 305 repeatedly until head pointer 315 points to an entry 310 whose status field indicates that that entry 310 of ring buffer 305 is free. Alternatively, the status field may be handled separately from entries 310: for example, as an auxiliary array indicating whether each corresponding entry 310 of ring buffer 305 is awaiting processing or not.

In case this is not clear, consider the following. Accompanying ring buffer 305 may be an array of bits (not shown in FIG. 3): one bit for each entry 310 of ring buffer 305. This bit may be set, for example, to one to indicate that the corresponding entry 310 in ring buffer 305 includes a request waiting to be processed. When storage device 120 of FIG. 1 processes a request from an entry 310 in ring buffer 305, storage device 120 of FIG. 1 may change the bit in the auxiliary array corresponding to that entry 310 in ring buffer 305 to zero, to indicate that the corresponding entry 310 in ring buffer 305 has been processed. Then, when processor 110 of FIG. 1 is ready to update tail pointer 320 (because a response in the entry 310 in ring buffer 305 pointed to by tail pointer 320 has been processed by processor 110 of FIG. 1), processor 110 of FIG. 1 may locate the next bit in the auxiliary array set to one, and adjust tail pointer 320 to point to entry 310 of ring buffer 305 that corresponds to the bit in the auxiliary array so identified as set to one. (Obviously, the significance of the values zero and one may be interchanged without any loss of applicability.)

While FIG. 3 shows ring buffer 305 as including eight entries 310, embodiments of the disclosure may include any number (one or more, without bound) of entries 310 of ring buffer 305. The number of entries 310 of ring buffer 305 may be effectively bounded by only the memory available for ring buffer 305 and its related data structures. But as memory may be used for other purposes as well, the size of the available memory alone may not be the only limitation on the size of ring buffer 305.

While using an array of memory addresses is one way to implement ring buffer 305, embodiments of the disclosure may use other implementations as well. For example, ring buffer 305 may be implemented as a linked list, where head pointer 315 points to the first entry 310 in the list, tail pointer 320 points to the last entry 310 in the list, and every entry 310 in the list (except for the last entry 310) points to its successor entry 310. Linked lists may avoid using modulo arithmetic to determine the address for the next entry, and may also be unbounded (except by the capacity of subsystem local memory 325 of FIG. 3). When processor 110 of FIG. 1 needs to place a new entry 310 in the linked list, processor 110 of FIG. 1 may allocate a block of memory for the new entry 310, place the request in the new entry 310, then add the new entry to the linked list (by having both the entry 310 pointed to by tail pointer 320 and tail pointer 320 itself point to the new entry 310, and having the new entry 310 include a null pointer for its successor). When storage device 120 of FIG. 1 wants to process a request from an entry 310 in the linked list, storage device 120 of FIG. 1 may verify that the entry exists by checking that head pointer 315 is not a null pointer: if so, receiving device 120 may read the request from the entry 310 pointed to be head pointer 315, and may store any result in entry 310. Processor 110 of FIG. 1, after reading the response from entry 310, may update head pointer 315 to point to the successor entry 310 of the entry 310 that was pointed to be head pointer 315 and deallocating the memory used by the (now processed) entry 310. Note that if processor 110 of FIG. 1 needs to remove an entry 310 from the middle of the linked list (for example, because processor 110 of FIG. 1 is more interested in that request than earlier requests), such an entry may be removed simply by changing the pointer of the entry 310 that pointed to the entry 310 being removed to point instead to the entry currently pointed to by the entry 310 being removed. The memory used by the entry 310 being removed may then be deallocated.

While the above descriptions suggest that the auxiliary list might be used only to indicate whether a particular entry 310 in ring buffer 305 is waiting to be processed, the auxiliary list may also include additional information. Since the auxiliary list may act as metadata, other metadata for entries 310 in ring buffer 305 may also be included in the auxiliary list. For example, as discussed with reference to FIG. 4 below, entries 310 may include information such as an opcode of the request, a buffer identifier, a namespace identifier, or a logical address of the data to be processed. Any or all of such information might be stored in an auxiliary list rather than in entries 310 of ring buffer 305. In addition, such an auxiliary list might be used to store additional data relevant to the request: for example, if the request involves additional data beyond just the opcode and logical address, such additional data may be stored in the auxiliary list. As a particular example, if storage device 120 of FIG. 1 is associated with an accelerator and the request involves processing by the accelerator, the accelerator might expect additional parameters to know how to carry out the processing request: the auxiliary list might be used to store those additional parameters.

While FIG. 3 shows embodiments of the disclosure using ring buffer 305, other embodiments of the disclosure may also use other data structures, such as a linked list (discussed above), a First In, First Out (FIFO queue), a priority queue, or more generally, any form of queue. Any reference to a “ring buffer” below should be understood as extending to other types of data structures, such as fixed size queues or queues generally, whether or not explicitly discussed.

Ring buffer 305 may be used for processing of any type of request. Such requests may include, for example, read requests from storage device 120 of FIG. 1, so that processor 110 of FIG. 1 may stream data from storage device 120 of FIG. 1 to a destination (such as for playback to a user). In such situations, the requests in entries 310 of ring buffer 305 may be requests to read portions of data from storage device 120 of FIG. 1, with the responses being the return of the data read from storage device 120 of FIG. 1. But ring buffer 305 may also be used for other types of requests. For example, data may be streamed to storage device 120 of FIG. 1 for writing. In such situations, the requests in entries 310 of ring buffer 305 may be requests to write portions of data to storage device 120 of FIG. 1, with the responses being confirmation that the data was successfully written. Or, as noted above, the requests in entries 310 of ring buffer 305 may be requests for processing of data by an accelerator associated with storage device 120 of FIG. 1: storage device 120 of FIG. 1 may read the data from storage device 120 of FIG. 1, deliver the data to the associated accelerator, which may then process the data and return the result to processor 110 of FIG. 1 just as though storage device 120 of FIG. 1 might return a result to a read or write request. Ring buffer 305 may also be used with devices other than storage device 120 of FIG. 1: for example, data might be streamed to or from a network interface card, or potentially to or from any other component in machine 105 of FIG. 1.

When data is being streamed, it may be desirable that data be provided at a particular rate, which may be described as isochronous communication. For example, if the data being streamed is expected to be delivered at a rate of 30 frames per second, then it may be desirable for storage device 120 of FIG. 1 (or whatever device is processing the requests) to process requests at a rate sufficient to provide enough data to satisfy 30 frames per second. If, for example, a frame consists of 4 kilobytes (KB) of data, then storage device 120 of FIG. 1 may be expected to process 4 KB of data 30 times per second, or 4 KB of data approximately every 33 milliseconds (ms). If a frame is larger or smaller than 4 KB, then the amount of data expected to be processed may also change accordingly.

The amount of data processed as a result of each request may also impact the rate at which requests may be processed by storage device 120 of FIG. 1. For example, assume that storage device 120 of FIG. 1 stores data in 4 KB blocks, which means that each request to read data from storage device 120 of FIG. 1 may return 4 KB of data. If the size of each frame is only 4 KB, then storage device 120 of FIG. 1 may need to process only one request to satisfy each frame of data being streamed. But if the size of each frame is, for example, 16 KB, then storage device 120 of FIG. 1 may need to process four requests to satisfy each frame of data being streamed. If data is to be streamed at a particular rate, such as 30 frames of data per second, then with 4 KB frames, storage device 120 of FIG. 1 only needs to process one request every 33 ms; but with 16 KB frames, storage device 120 of FIG. 1 may need to process four requests every 33 ms.

Processor 110 of FIG. 1 may communicate to storage device 120 of FIG. 1 the desired interval of streaming. Storage device 120 of FIG. 1 may then use this interval to determine the rate at which requests may be processed from ring buffer 305. The interval may expressed in any desired manner: as a rate at which individual requests may be processed (such as 30 requests per second or one request every 33 ms), as a rate at which data should be processed (such as 122 KB per second), or as rate at which frames (of an agreed size) should be processed, among other possibilities. Embodiments of the disclosure may support any other methods of defining the desired interval, without limitation. Storage device 120 of FIG. 1 (or whatever device is processing requests from ring buffer 305) may then process requests from ring buffer 305 at the appropriate rate to satisfy the specified interval. Processor 110 may notify storage device 120 of FIG. 1 about the interval using, for example, an administrative command.

Some embodiments of the disclosure may depend on processor 110 of FIG. 1 knowing the size of data being returned from storage device 120 of FIG. 1. For example, for processor 110 of FIG. 1 to specify a particular rate at which requests should be processed, processor 110 of FIG. 1 may need to know the size of data being returned from storage device 120 of FIG. 1 in response to an individual request, whereas to specify a particular rate at which data should be processed, processor 110 of FIG. 1 may not need to know how much data is returned by storage device 120 of FIG. 1 in response to an individual request. But since isochronous communication implies that storage device 120 of FIG. 1 streams data at the specified rate and that processor 110 of FIG. 1 consumes that data at the specified rate, in some embodiments of the disclosure processor 110 of FIG. 1 may know the rate at which storage device 120 of FIG. 1 streams data whether or not that information is needed to determine the interval specified by processor 110 of FIG. 1 to storage device 120.

FIG. 4 shows details of entry 310 of FIG. 3, according to embodiments of the disclosure. In FIG. 4, entry 310 is shown in greater detail. Entry 310 may include field 405 for control information, status information, and/or buffer identifier, field 410 for a namespace identifier, and field 415 for a logical address of the data to be processed. In some embodiments of the disclosure, the size of entry 310 may be determined in advance and may be the same for all entries 310, regardless of what request is placed in entries 310. By having entries 310 be consistently sized, the arithmetic described above to calculate the address where entries are stored may be used: having entries 310 be of variable size would mean that the size of entries 310 is not constant, and would make the arithmetic more complicated.

In some embodiments of the disclosure, fields 405 and 410 may each be 32 bits, and field 415 may be 64 bits, for a total size of 128 bits (16 bytes). In other embodiments of the disclosure, fields 405, 410, and 415 may have other sizes.

The control information in field 405 may be, for example, to identify the command that processor 110 of FIG. 1 has requested be performed. For example, the control information may be an opcode or a feature identifier, from which storage device 120 of FIG. 1 may know what command to perform. The number of bits needed to distinguish the various different functions offered by storage device 120 of FIG. 1 may be relatively small, and therefore the number of bits in field 405 for the control information may be relatively few in number.

The status information in field 405 may be, for example, a few bits indicating the status of the request. For example, the status information might use one value to indicate that a request is pending processing by storage device 120 of FIG. 1, another value to indicate that a request has been successfully performed by storage device 120 of FIG. 1, and a third value to indicate that an error has occurred during processing of the request by storage device 120 of FIG. 1. The exact details about the error may be stored elsewhere for retrieval by processor 110 of FIG. 1, meaning that only two bits may be needed for the status information. Alternatively, in some embodiments of the disclosure, if the number of possible error conditions is relatively few in number, more bits may be used to represent all possible values indicating that an error occurred during processing of the request by storage device 120.

As just noted, in some embodiments of the disclosure, details about the error may be stored elsewhere. It might also be noted that if entry 310 is only 16 bytes in size, there is little room for data to be read from storage device 120 of FIG. 1 to be returned to processor 110 of FIG. 1. To provide for additional space for data that might need to be exchanged between processor 110 of FIG. 1 and storage device 120 of FIG. 1, buffers may be used. In FIG. 4, buffers 420-1, 420-2, and 420-3 are shown. Buffers 420-1, 420-2, and 420-3 may be referred to collectively as buffers 420. Buffers 420 may provide additional storage space for data to be exchanged between processor 110 of FIG. 1 and storage device 120 of FIG. 1. For example, buffers 420 may be used to store data to be written to storage device 120 of FIG. 1, to storage data read from storage device 120 of FIG. 1, and/or to store information about an error that might have occurred during processing of a request by storage device 120 of FIG. 1, among other possible uses.

While FIG. 4 shows three buffers 420, embodiments of the disclosure may include any number (zero or more, without bound) of buffers 420. Because each request sent from processor 110 of FIG. 1 to storage device 120 of FIG. 1 may involve some data to be processed-for example, if processor 110 of FIG. 1 is using ring buffer 305 of FIG. 3 to stream data read from storage device 120 of FIG. 1—it may be expected that there is at least one buffer 420 for each entry 310 (although the number of buffers 420 per entry 305 may be greater or less than one).

Buffers 420 may be sized consistently for use by processor 110 of FIG. 1 in memory 115 of FIG. 1. Thus, in some embodiments of the disclosure, buffers 420 may each be sized the same as a memory page: for example, 4 KB. But embodiments of the disclosure may support buffers 420 being of any desired size.

Sizing buffers 420 to store a memory page may have advantages other than being consistently sized with other memory. For example, it may be that storage device 120 of FIG. 1 stores data in pages, blocks, sectors, or some other unit that may also be 4 KB in size. This fact means that when storage device 120 of FIG. 1 processes a request, the data being processed may fit optimally in buffer 420.

But as storage devices 120 of FIG. 1 grow in capacity, the basic unit size of storage devices 120 of FIG. 1 may change. For example, while the current page size of a SSD is often 4 KB, customers are beginning to request larger page sizes, such as 16 KB or 64 KB. Larger page sizes for SSDs may mean that more data may be written to the SSD or read from the SSD in a single operation. But it may be expected that the page size for memory may continue to remain at, say, 4 KB for some time. Thus, it may come to pass that the page size of an SSD may be larger than the size of buffer 420. In such situations, buffers 420 may be made larger to store enough data that might be read from or written to storage device 120 of FIG. 1. Alternatively, the size of buffers 420 may remain consistent with the size of a page of memory 115 of FIG. 1, but additional buffers 420 may be used to store the data being read from or written to storage device 120 of FIG. 1, to account for the difference in the unit sizes of memory 115 of FIG. 1 and storage device 120 of FIG. 1.

In some embodiments of the disclosure, even if the sizes of buffers 420 and the sizes of pages in storage device 120 of FIG. 1 differ, it may be expected that the sizes of pages in storage device 120 of FIG. 1 may be an integer multiple of the sizes of buffers 420. Thus, while more than one buffer 420 might be used to store data read from or written to storage device 120 of FIG. 1, it may be expected that all buffers 420 so used may be filled completely. This expectation is a consequence of the fact that memory 115 of FIG. 1 and storage device 120 of FIG. 1 store binary data, which is most conveniently stored in units that are powers of 2. Thus, even if storage device 120 of FIG. 1 stores pages that are 16 KB or 64 KB in size, the number of buffers 420 needed to store that data may be an integer multiple of the size of buffers 420 (for example, four or 16 buffers 420, respectively).

Buffers 420 may be allocated by processor 110 of FIG. 1 at the same time as allocating memory for ring buffer 305 of FIG. 3. In some embodiments of the disclosure, buffers 420 may be allocated in a contiguous block of memory. By allocating buffers 420 in a contiguous block of memory, an individual buffer may be identified using a relatively small number of bits, and each buffer's address in memory may be quickly determined. For example, if the base address of buffers 420 is b and the size of each buffer 420 is s, then the address for the i^{th} buffer may be calculated as aᵢ=b+((i−1)×s). (This equation assumes that the first buffer 420 is identified as buffer number one: if numbering of buffers 420 starts at zero, then (i−1) in the above equation may be replaced with i.) Thus, instead of needing 64 bits to store the address where buffer 420 is located in memory, only a few bits of field 405 may be used to store the buffer identifier (shown as the dashed line from field 405 to buffers 420). The buffer identifier may therefore associate one (or more) particular buffers 420 with entry 310. For example, if there are eight buffers 420, then only three bits are needed to identify each buffer 420 (2³=8); if there are 64 buffers 420, then only six bits are needed (2⁶=64), and so on. Even if multiple buffers are used to store data for a request in entry 310, the number of bits needed to represent each buffer 420 may be less than the number of bits needed to represent the address where each buffer 420 begins. Thus, for example, if storage device 120 of FIG. 1 reads or writes data in 16 KB chunks but buffers 420 are 4 KB in size (and therefore four buffers 420 may be used to store all the data to be written or read), entry 310 may store the identifier of the first buffer 420 in which the data is written or read, and the following buffers 420 may be used automatically after the first buffer 420 is filled.

In embodiments of the disclosure where buffers 420 might not be allocated as a contiguous block of memory, entry 310 may be modified. Instead of storing an identifier for buffer 420, entry 310 may include one (or more, as needed) address fields for each buffer 420. But in such embodiments of the disclosure, the size of entry 310 may be increased.

Field 410 may be used to store a namespace identifier. A namespace may be a way to organize information stored on storage device 120 of FIG. 1. For example, a block of physical addresses on storage device 120 of FIG. 1 might be associated with a particular namespace. While as a general rule different data should not be identified by the same identifier, namespaces provide a mechanism to distinguish between or among all the data that might be identified using that identifier.

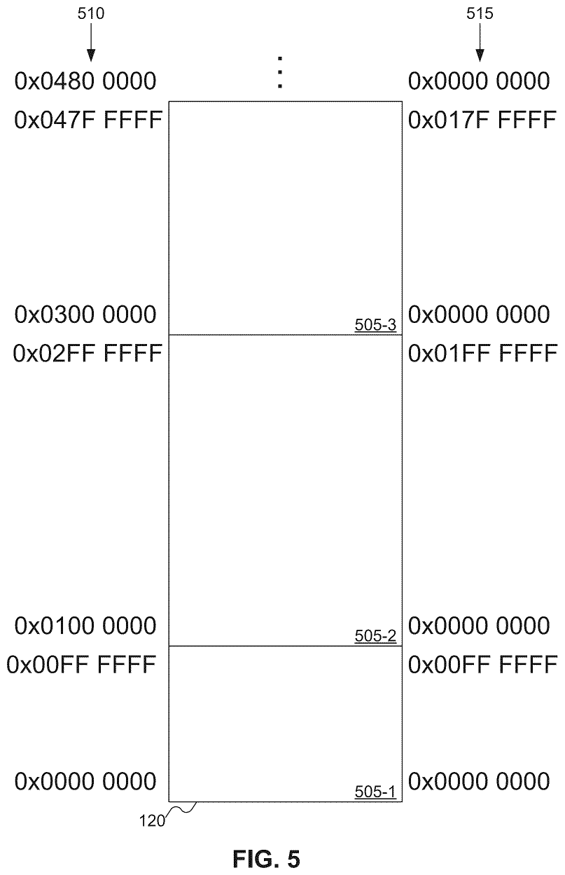

For example, consider FIG. 5, which shows storage device 120 of FIG. 1 divided into namespaces. In FIG. 5, storage device 120 includes namespaces 505-1, 505-2, and 505-3, which may be referred to collectively as namespaces 505. Each namespace 505 may include a portion of the addresses available within storage device 120.

On the left side of FIG. 5, physical addresses 510 of data in namespaces 505 are shown. Thus, for example namespace 505-1 includes physical addresses ranging from 0x0000 0000 through 0x00FF FFFF, namespace 505-2 includes physical addresses ranging from 0x0100 0000 though 0x02FF FFFF, and namespace 505-3 includes physical addresses ranging from 0x0300 0000 through 0x047F FFFF. Note that each physical address may be associated with a unique location in storage device 120: no two locations in storage device 120 may be associated with the same physical address.

On the right side of FIG. 5, logical addresses 515 of data in namespaces 505 are shown. Note that each namespace 505 may start with the same logical address (0x0000 0000), which means that the logical address 0x0000 0000 is associated with data in each namespace 505. But by specifying a particular namespace 505 using a namespace identifier, a unique location in storage device 120 may be determined. For example, the logical address 0x0000 0000 in namespace 505-2 uniquely identifies the data at physical address 0x0100 0000.

There are at least benefits of using namespaces 505. First, by logically dividing storage device 120 into namespaces 505, the size of (logical) address 515 may be reduced, which may save the amount of space needed to represent where the requested data is stored. Second, by dividing storage device 120 into namespaces 505, it may be possible to impose some security on storage device 120. For example, different applications may be assigned to access data from different namespaces 505. If an application attempts to access data outside its namespace 505, storage device 120 may prevent such access. In addition, if the application attempts to access logical address 515 that is not found in namespace 505, storage device 120 may return an error. For example, if an application attempts to access logical address 515 0x0200 0000 from namespace 505-2, storage device 120 may return an error, as this logical address 515 does not exist within namespace 505-2.

Returning to FIG. 4, field 415 may store the identifier of namespace 505 of FIG. 5, which may thus permit storage device 120 of FIG. 1 to differentiate among multiple data that might be identified by a single logical address 515 of FIG. 5.

Finally, field 415 may be used to store logical address 515 of FIG. 5 of the data. There are at least two reasons why logical address 515 of FIG. 5 may be stored in field 415, rather than physical address 510 of FIG. 5. First, as discussed above, namespaces 505 of FIG. 5 may provide some security to prevent applications from accessing data to which they should not be permitted access. Second, some storage devices 120 of FIG. 1, such as SSDs, may relocate data within storage device 120 of FIG. 1 for various reasons. If processor 110 of FIG. 1 used physical address 510 of FIG. 5 in field 415, then storage device 120 of FIG. 1 would need to inform processor 110 of FIG. 1 every time the data was moved to a different physical address 510 of FIG. 1. By using logical address 515 of FIG. 5, storage device 120 of FIG. 1 may move data around among physical addresses 510 of FIG. 5 without having to notify processor 110 of FIG. 1 every time data is moved. Storage device 120 may simply track where the data is currently stored, mapping logical address 515 of FIG. 5 to actual physical address 510 where the data is currently stored.

It was discussed above that processor 110 of FIG. 1 may allocate memory for ring buffer 305 of FIG. 3 and buffers 420. These data structures may be stored in any desired location, provided that both processor 110 of FIG. 1 and storage device 120 of FIG. 1 may be able to access ring buffer 305 of FIG. 3 and buffers 420. Memory 115 of FIG. 1, which is associated with processor 110 of FIG. 1, is one possible location where these data structures may be stored. Another possible location would be an auxiliary memory element. For example, some devices may be used to extend memory 115 of FIG. 1, permitting processor 110 of FIG. 1 to access data as though that data was in memory 115 of FIG. 1. That is, processor 110 of FIG. 1 may issue requests to load or store data in the memory of such devices. Examples of such devices may include, for example cache-coherent interconnect protocol storage devices, of which a CXL-protocol compliant storage device may be an example. Storage device 120 of FIG. 1 may be such a device, in which case ring buffer 305 of FIG. 3 and buffers 420 may be stored in storage device 120 of FIG. 1 (or a memory associated with such a device).

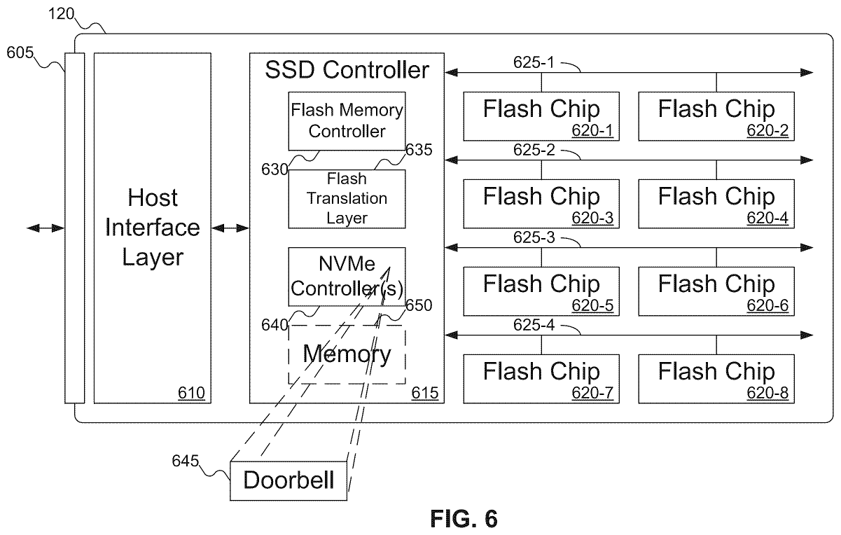

FIG. 6 shows details of storage device 120 of FIG. 1, according to embodiments of the disclosure. In FIG. 6, storage device 120 is shown using an implementation including SSD 120, but embodiments of the disclosure are applicable to any type of storage device that may support caching of data, as discussed below.

SSD 120 may include interface 605 and host interface layer 610. Interface 605 may be an interface used to connect SSD 120 to machine 105 of FIG. 1. Examples of such interfaces may include Serial AT Attachment (SATA), mSATA, Serial Attached Small Computer Systems Interface (SCSI) (SAS), NVMe, PCIe, U.2, M.2, and Enterprise and Datacenter Standard Form Factor (EDSFF): other interfaces are also possible. SSD 120 may include more than one interface 605: for example, one interface might be used for block-based read and write requests, and another interface might be used for key-value read and write requests. While FIG. 6 suggests that interface 605 is a physical connection between SSD 120 and machine 105 of FIG. 1, interface 605 may also represent protocol differences that may be used across a common physical interface. For example, SSD 120 might be connected to machine 105 of FIG. 1 using a U.2, EDSFF, or an M.2 connector, among other possibilities, and SSD 120 may support block-based requests and key-value requests: handling the different types of requests may be performed by a different interface 605. SSD 120 may also include a single interface 605 that may include multiple ports, each of which may be treated as a separate interface 605, or just a single interface 605 with a single port, and leave the interpretation of the information received over interface 605 to another element, such as SSD controller 615.

Host interface layer 610 may manage interface 605, providing an interface between SSD controller 615 and the external connections to SSD 120. If SSD 120 includes more than one interface 605, a single host interface layer 610 may manage all interfaces, SSD 120 may include a host interface layer 610 for each interface, or some combination thereof may be used.

SSD 120 may also include SSD controller 615 and various flash memory chips 620-1 through 620-8, which may be organized along channels 625-1 through 625-4. Flash memory chips 620-1 through 620-8 may be referred to collectively as flash memory chips 620, and may also be referred to as flash chips, memory chips, NAND chips, chips, or dies. Channels 625-1 through 625-4 may be referred to collectively as channels 625.

SSD controller 615 may manage sending read requests and write requests to flash memory chips 620 along channels 625. Controller 615 may also include flash memory controller 630, which may be responsible for issuing commands to flash memory chips 620 along channels 625. Flash memory controller 630 may also be referred to more generally as memory controller 630 in embodiments of the disclosure where storage device 120 stores data using a technology other than flash memory chips 620. Although FIG. 6 shows eight flash memory chips 620 and four channels 625, embodiments of the disclosure may include any number (one or more, without bound) of channels 625 including any number (one or more, without bound) of flash memory chips 620.

Within each flash memory chip or die, the space may be organized into planes. These planes may include multiple erase blocks (which may also be referred to as blocks), which may be further subdivided into wordlines. The wordlines may include one or more pages. For example, a wordline for Triple Level Cell (TLC) flash media might include three pages, whereas a wordline for Multi-Level Cell (MLC) flash media might include two pages. In some embodiments of the disclosure, the page may be the smallest unit of data that may be written to or read from SSD 120; in other embodiments of the disclosure, the smallest unit of data that may be written to or read from SSD 120 may differ from the size of a page.

Erase blocks may also be logically grouped together by controller 615, which may be referred to as a superblock. This logical grouping may enable controller 615 to manage the group as one, rather than managing each block separately. For example, a superblock might include one or more erase blocks from each plane from each die in SSD 120. So, for example, if SSD 120 includes eight channels, two dies per channel, and four planes per die, a superblock might include 8×2×4=64 erase blocks.

SSD controller 615 may also include flash translation layer (FTL) 635 (which may be termed more generally a translation layer, for storage devices that do not use flash storage). FTL 635 may handle translation of logical block addresses (LBAs) or other logical IDs—for example, logical addresses 515 of FIG. 5, as used by processor 110 of FIG. 1 and physical block addresses (PBAs) or other physical addresses—for example, physical addresses 510 of FIG. 5—where data is stored in flash chips 620. FTL 635, may also be responsible for tracking data as it is relocated from one PBA to another, as may occur when performing garbage collection and/or wear leveling.

SSD controller 615 may also include controllers 640. In FIG. 6, controller 640 is identified as an NVMe controller, but in embodiments of the disclosure where storage device 120 does not support the NVMe protocol, other types of controllers 640 may be used. Controller 640 may enable communication using a particular protocol, and thus may be responsible for managing interpretation of commands using the particular protocol(s) supported by storage device 120.

While FIG. 6 shows SSD controller 615 as including one controller 640, embodiments of the disclosure may include any number (one or more, without bound) of controllers 640. In some embodiments of the disclosure, each controller 640 may support the same protocol(s); in other embodiments of the disclosure, different controllers 640 may support different protocols.

By including multiple controllers 640, it may be possible for SSD 120 to communicate with multiple hosts. The term “host” in this context may refer to various machines such as machine 105 of FIG. 1, communicating across a network. But the term “host” in this context may also refer to, for example, virtual machines executing on processor 110 of FIG. 1, or even multiple applications executing on processor 110 of FIG. 1. By including multiple controllers 640, each host may communicate with SSD 120 as though that host was the only host using SSD 120.

In addition, each controller 640 may offer various functions, which in some embodiments of the disclosure may be referred to as Physical Functions (PFs) or Virtual Functions (VFs). PFs are functions that have their own separate hardware to support the offered functions: two PFs might not share hardware. VFs, on the other hand, may be functions that do not have their own separate hardware, but may be associated with the hardware of some PF. By offering various functions, controllers 640 may offer various capabilities, which might or might not be offered by other controllers 640.

Each controller 640, and even each function offered by controller 640, may support its own ring buffer 305 of FIG. 3 and buffers 420 of FIG. 4. Thus, multiple hosts may be enabled to stream data in parallel from SSD 120 by using different controllers 640, or different functions of controllers 640.

Controller 640 may include doorbell 645. Doorbell 645 is an example of a notification mechanism that processor 110 of FIG. 1 may use to notify SSD 120 that a new request has been placed in ring buffer 305 of FIG. 3: processor 110 of FIG. 1 may “ring” doorbell 645. Since each controller 640, and each function offered by controller 640, may have its own ring buffer 305 of FIG. 3 and buffers 420 of FIG. 4, each controller 640 may have multiple doorbells 645: one for each ring buffer 305 of FIG. 3. Doorbell 645 may be repurposed from a doorbell used for notifying SSD 120 that a request has been placed in a submission queue of a submission queue/completion queue pair, or doorbell 645 may be a new doorbell added to controller 640.

Finally, SSD controller 615 may include memory 650. Memory 650 may be memory associated with SSD 120, in which ring buffer 305 of FIG. 3 and buffers 420 of FIG. 4 may be allocated, provided that both processor 110 of FIG. 1 and SSD 120 may access memory 650. Since ring buffer 305 of FIG. 3 and buffers 420 of FIG. 4 may be stored in memory 115 of FIG. 1, memory 650 may be omitted, as shown by the dashed lines.

It may happen that the data is stored in multiple locations. For example, the data that is stored in flash memory chips 620 or in buffers 420 of FIG. 4 might originally have been copied from somewhere else in memory 115 of FIG. 1 managed by processor 110 of FIG. 1. As a result, it might happen that data in one location is changed, but the corresponding data in another location is not changed. This situation may create inconsistencies in the data, which might result in incorrect processing of that data, either as part of the request placed in entry 310 of FIG. 3 of ring buffer 305 of FIG. 3 or sometime later.

To avoid such inconsistencies in the data, various protocols may be used to ensure data coherence. For example, cache-coherent interconnect protocols, of which the CXL protocols are one example, may support data coherence. But as the data may be stored in multiple locations, there are multiple ways to support data coherence. Since embodiments of the disclosure are concerned with SSD 120 processing a request on behalf of processor 110 of FIG. 1, some embodiments of the disclosure may support using a host bias mode, in which the data managed by the host is assumed to be the most current data. In host bias mode, SSD 120 may confirm that the data SSD 120 is accessing is the correct data by checking that data against the data managed by processor 110 of FIG. 1. In other embodiments of the disclosure, device bias mode may be used, in which the data stored on SSD 120 is assumed to be the most current data. In device bias mode, processor 110 of FIG. 1 may confirm that the data processor 110 of FIG. 1 is accessing is the correct data by checking that data against the data managed by SSD 120. Host bias mode may be used in situations where processor 110 of FIG. 1 is more often responsible for changing the data; device bias mode may be used in situations where processor 110 of FIG. 1 does not change the data often.

While FIG. 6 shows SSD controller 615 as including flash memory controller 630, flash translation layer 635, controller(s) 640, and memory 650, embodiments of the disclosure may have any, some, or all of these elements located outside SSD controller 615, without loss of generality.

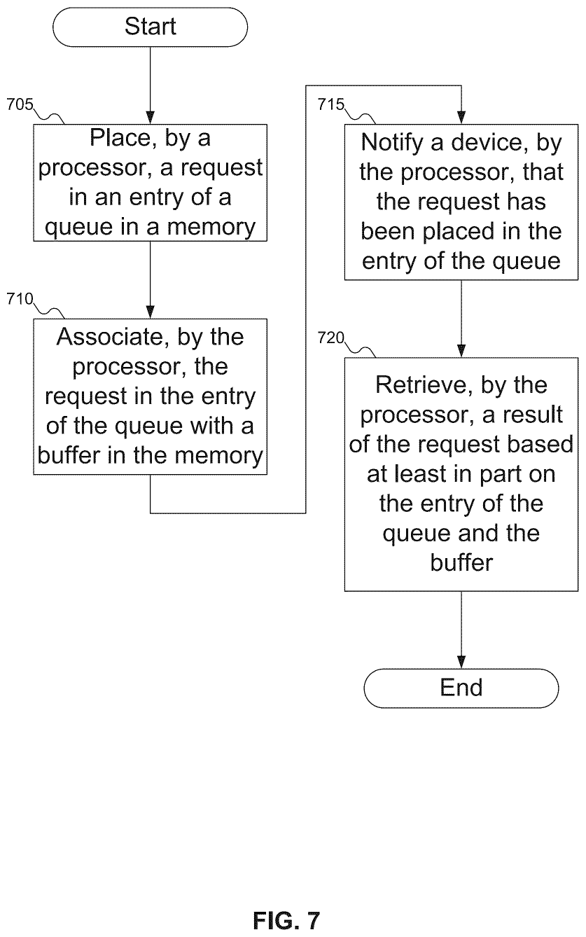

FIG. 7 shows a flowchart of an example procedure for processor 110 of FIG. 1 to use ring buffer 305 of FIG. 3, according to embodiments of the disclosure. In FIG. 7, at block 705, processor 110 of FIG. 1 may place a request in entry 310 of FIG. 3 of ring buffer 305 of FIG. 3. Ring buffer 305 of FIG. 3 may be stored in any desired memory, such as memory 115 or memory 650 of FIG. 6. At block 710, processor 110 of FIG. 1 may store a buffer identifier in field 405 of FIG. 4, associating buffer 420 of FIG. 4 with entry 310 of FIG. 3. At block 715, processor 110 of FIG. 1 may notify storage device 120 of FIG. 1 that the request has been placed in entry 310 of FIG. 3. Processor 110 of FIG. 1 may notify storage device 120 of FIG. 1 by, for example, “ringing” doorbell 645 of FIG. 6. Finally, at block 720, processor 110 of FIG. 1 may retrieve a result of the request from entry 310 and/or buffer 420 of FIG. 4.

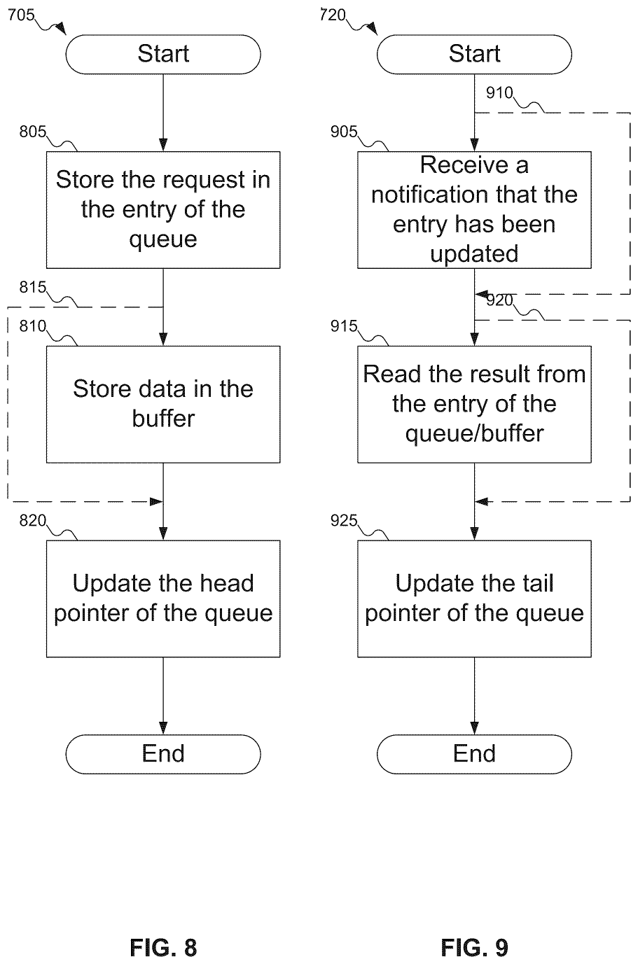

FIG. 8 shows a flowchart of an example procedure for processor 110 of FIG. 1 to place a request in entry 310 of FIG. 3, according to embodiments of the disclosure. In FIG. 8, at block 805, processor 110 of FIG. 1 may store the request in entry 310 of FIG. 3. At block 810, processor 110 of FIG. 1 may store any relevant data in buffer 420 of FIG. 4. For example, if the request is to write data to storage device 120 of FIG. 1, then buffer 420 of FIG. 4 may be used to store the data to be written to storage device 120 of FIG. 1. Note that if the request does not involve any data being sent from processor 110 of FIG. 1 to storage device 120 of FIG. 1 using buffer 420 of FIG. 4, then block 810 may be omitted, as shown by dashed line 815. Finally, at block 820, processor 110 of FIG. 1 may update head pointer 315 of FIG. 3.

FIG. 9 shows a flowchart of an example procedure for processor 110 of FIG. 1 to retrieve a result from entry 310 of FIG. 3, according to embodiments of the disclosure. At block 905, processor 110 of FIG. 1 may receive a notification from storage device 120 of FIG. 1 that entry 310 of FIG. 3 has been updated: for example, by responding to the request placed in entry 310 of FIG. 1 by processor 110 of FIG. 1 (as might happen at block 705 of FIG. 7, for example). Note that in some embodiments of the disclosure, block 905 may be omitted, as shown by dashed line 910. For example, if processor 110 of FIG. 1 periodically checks entries 310 of FIG. 3 to see if there has been any processing by storage device 120 of FIG. 1, then storage device 120 of FIG. 1 might not send an interrupt to processor 110 of FIG. 1 after processing entry 310 of FIG. 3. At block 915, processor 110 of FIG. 1 may read the result from entry 310 and/or buffer 420 of FIG. 4. Note that if the result may fit in entry 310 of FIG. 3, then there might be no data in buffer 420, and therefore no need to access buffer 420 of FIG. 4. In some situations, storage device 120 of FIG. 1 might not return any result at all (other than to change the status in field 405 of FIG. 4 of entry 310 of FIG. 3), in which case block 915 may be omitted, as shown by dashed line 920. Finally, at block 925, processor 110 of FIG. 1 may update tail pointer 320 of FIG. 3 to reflect that the result has been read from entry 310 of FIG. 3.

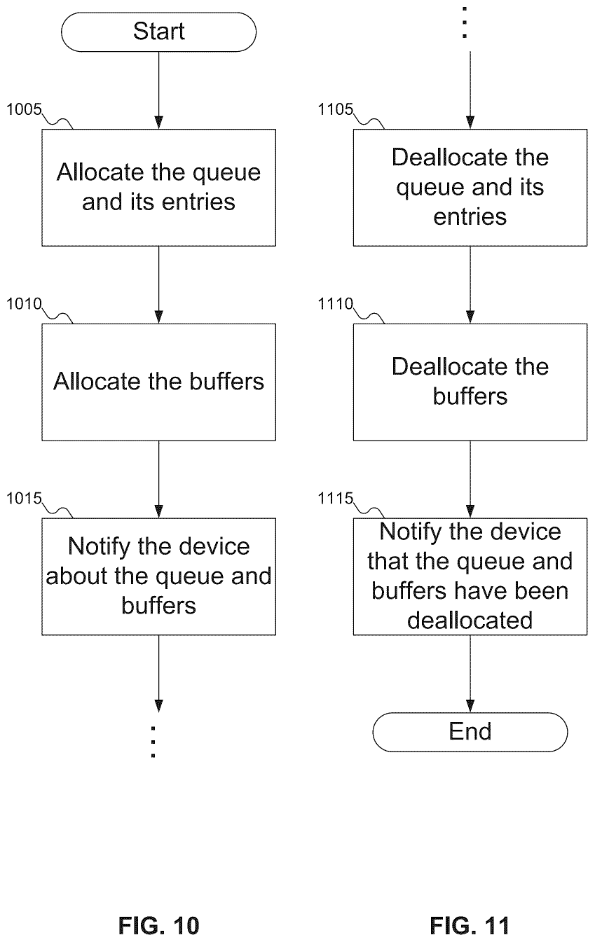

FIG. 10 shows a flowchart of an example procedure for processor 110 of FIG. 1 to allocate ring buffer 305 of FIG. 3 and buffers 420 of FIG. 4, according to embodiments of the disclosure. In FIG. 10, at block 1005, processor 110 of FIG. 1 may allocate ring buffer 305 and entries 310 of FIG. 3 from a memory, such as memory 110 or memory 650 of FIG. 6 accessible to both processor 110 and storage device 120 of FIG. 1. At block 1010, processor 110 of FIG. 1 may allocate buffers 420 of FIG. 4 from a memory, such as memory 110 or memory 650 of FIG. 6 accessible to both processor 110 and storage device 120 of FIG. 1. Finally, at block 1015, processor 110 of FIG. 1 may notify (using, for example, an administrative command) storage device 120 of FIG. 1 about ring buffer 305 of FIG. 3, entries 310, and buffers 420 of FIG. 4, so that storage device 120 of FIG. 1 may access ring buffer 305 of FIG. 3, entries 310, and buffers 420 of FIG. 4.

FIG. 11 shows a flowchart of an example procedure for processor 110 of FIG. 1 to deallocate ring buffer 305 of FIG. 3 and buffers 420 of FIG. 4, according to embodiments of the disclosure. In FIG. 11, at block 1105, processor 110 of FIG. 1 may deallocate ring buffer 305 and entries 310 of FIG. 3 from a memory, such as memory 110 or memory 650 of FIG. 6 accessible to both processor 110 and storage device 120 of FIG. 1. At block 1110, processor 110 of FIG. 1 may deallocate buffers 420 of FIG. 4 from a memory, such as memory 110 or memory 650 of FIG. 6 accessible to both processor 110 and storage device 120 of FIG. 1. Finally, at block 1115, processor 110 of FIG. 1 may notify (using, for example, an administrative command) storage device 120 of FIG. 1 that ring buffer 305 of FIG. 3, entries 310, and buffers 420 of FIG. 4 have been deallocated, so that storage device 120 of FIG. 1 will not try to access ring buffer 305 of FIG. 3, entries 310, and buffers 420 of FIG. 4.

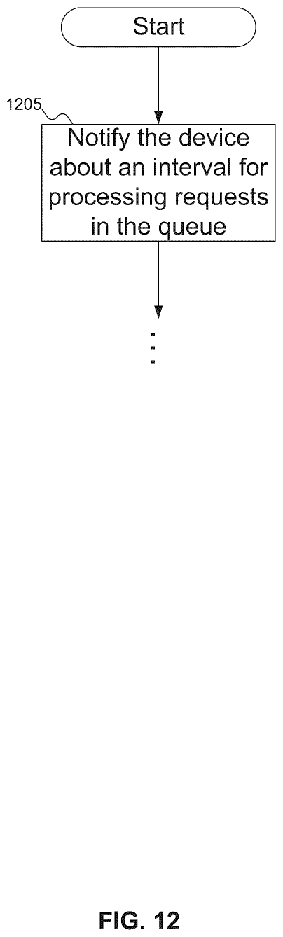

FIG. 12 shows a flowchart of an example procedure for processor 110 of FIG. 1 to notify storage device 120 of FIG. 1 about an interval for using ring buffer 305 of FIG. 3, according to embodiments of the disclosure. At block 1205, processor 110 of FIG. 1 may notify storage device 120 of FIG. 1 about the desired interval. As discussed with reference to FIG. 3 above, this interval may specify a number of requests to be processed in an interval of time, an amount of time to wait between processing requests, an amount of data to be processed in an interval of time, or any other desired variation that informs storage device 120 of FIG. 1 about how much data storage device 120 of FIG. 1 should process in a given interval of time.

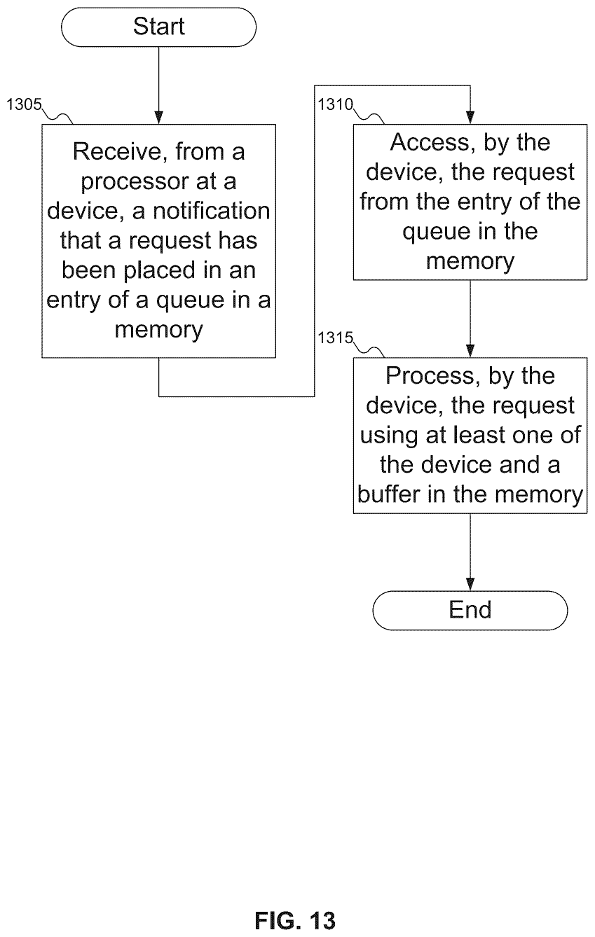

FIG. 13 shows a flowchart of an example procedure for storage device 120 of FIG. 1 to use ring buffer 305 of FIG. 3, according to embodiments of the disclosure. In FIG. 13, at block 1305, storage device 120 of FIG. 1 may receive a notification from processor 110 of FIG. 1 that a request has been placed in entry 310 of FIG. 3 of ring buffer 305 of FIG. 3. Such a notification may come from, for example, processor 110 of FIG. 1 ringing doorbell 645 of FIG. 6. At block 1310, storage device 120 of FIG. 1 may access the request from entry 310 of FIG. 3. Finally, at block 1315, storage device 120 of FIG. 1 may process the request, potentially using buffer 420 of FIG. 4.

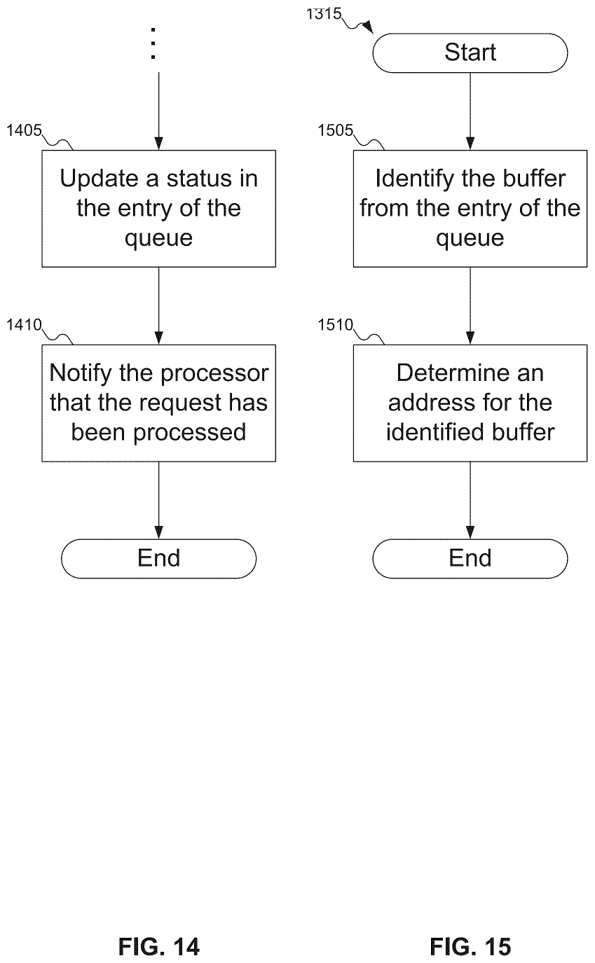

FIG. 14 shows a flowchart of an example procedure for storage device 120 of FIG. 1 to return a result to processor 110 of FIG. 1 using ring buffer 305 of FIG. 3, according to embodiments of the disclosure. In FIG. 14, at block 1405, storage device 120 of FIG. 1 may update the status in field 405 of FIG. 4 of entry 310 of FIG. 3 of ring buffer 305 of FIG. 3. Finally, at block 1410, storage device 120 of FIG. 1 may notify processor 110 of FIG. 1 that processing of the request in entry 310 of FIG. 3 of ring buffer 305 of FIG. 3 is complete. This notification may be done by, for example, issuing an MSI-X interrupt to processor 110 of FIG. 1.

FIG. 15 shows a flowchart of an example procedure for storage device 120 of FIG. 1 to determine the address of buffer 420 of FIG. 4, according to embodiments of the disclosure. In FIG. 15, at block 1505, storage device 120 of FIG. 1 may determine the buffer identifier from field 405 of FIG. 4 of entry 310 of FIG. 3 of ring buffer 305 of FIG. 3. Finally, at block 1510, storage device 120 of FIG. 1 may calculate the address of buffer 420 of FIG. 4 identified by the buffer identifier. As discussed with reference to FIG. 4 above, the address of buffer 420 of FIG. 4 identified by the buffer identifier may be determined using the base address of buffers 420 of FIG. 4, the buffer identifier, and the size of each buffer 420 of FIG. 4.

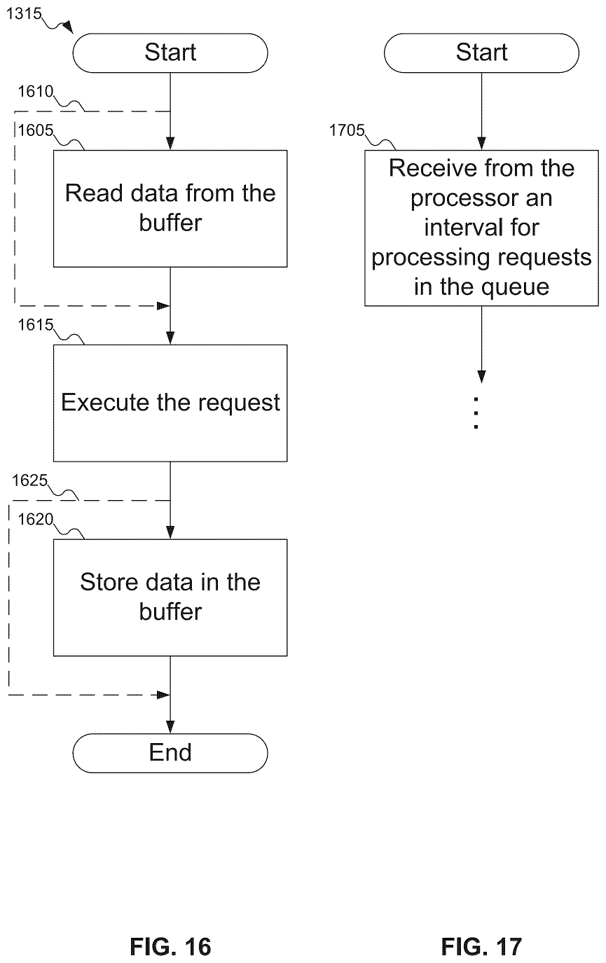

FIG. 16 shows a flowchart of an example procedure for storage device 120 of FIG. 1 to process a request from ring buffer 305 of FIG. 3, according to embodiments of the disclosure. In FIG. 16, at block 1605, storage device 120 of FIG. 1 may read data from buffer 420 of FIG. 4. Storage device 120 of FIG. 1 may read data from buffer 420 of FIG. 4 if processor 110 of FIG. 1 has provided that data to storage device 120 of FIG. 1: for example, if the request is to write data to storage device 120 of FIG. 1. If no data is stored in buffer 420 of FIG. 4, the block 1605 may be omitted, as shown by dashed line 1610.

At block 1615, storage device 120 of FIG. 1 may execute the request, performing whatever operation(s) were requested by processor 110 of FIG. 1. Finally, at block 1620, storage device 120 of FIG. 1 may store data, relevant to the result of the request, in buffer 420 of FIG. 4. Storage device 120 of FIG. 1 may store data in buffer 420 of FIG. 4 if the request executed in block 1615 results in data to be returned to processor 110 of FIG. 1 from storage device 120 of FIG. 1: for example, if the request is to read data from storage device 120 of FIG. 1. If no data is to be stored in buffer 420 of FIG. 4, the block 1620 may be omitted, as shown by dashed line 1625.

FIG. 17 shows a flowchart of an example procedure for storage device 120 of FIG. 1 to use ring buffer 305 of FIG. 3 with an interval, according to embodiments of the disclosure. At block 1705, storage device 120 of FIG. 1 may receive a notification from processor 110 of FIG. 1 about the desired interval. As discussed with reference to FIG. 3 above, this interval may be specify a number of requests to be processed in an interval of time, an amount of time to wait between processing requests, an amount of data to be processed in an interval of time, or any other desired variation that informs storage device 120 of FIG. 1 about how much data storage device 120 of FIG. 1 should process in a given interval of time.

In FIGS. 7-17, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may include a queue used to exchange requests between a processor and a device. The queue, which may be, for example, a ring buffer, may enable streaming of data between the processor and the device, without the processor having to issue individual requests through a submission queue. The use of the queue may avoid latencies that may be introduced through the use of the submission queue/completion queue pair, thereby providing faster return of data.

NVMe lacks support for read streaming operations between the device and host. To read data involves placement of a Submission Queue Entry (SQE) read command, which is loaded into a Submission Queue (SQ). The host may wait for a Completion Queue Entry (CQE) read completion in the Completion Queue (CQ), which may involve overhead. Current implementations of streaming rely on the host buffering data, which may increase host memory utilization.

Embodiments of the disclosure address this issue to add streaming capability that would support continuous data streaming applications like video, audio, and real-time analytics. Such streaming capabilities may include isochronous capabilities to reduce host memory overhead and instead provide data when it's needed (as a function of the stream type).

The host may create a ring buffer in memory with a given size. The ring buffer may be initialized (head=tail=0). The host may communicate the ring address and size to the controller as well as the base address for the buffers (which may be contiguous: if the ring buffer is not contiguous, the host may communicate the locations of the various portions of the ring buffer). Multiple rings may exist, per function/controller.

The host may manage the head and tail. The controller may update the Control/Status of a ring entry for completion/error. The Controller may hijack the head/tail doorbell for controller notification (head advanced). The Controller may hijack a MSI-X interrupt for host notification (read completed, tail advanced).

A ring may include an interval, indicating how often reads should be completed for a given ring for isochronous communication. A ring may be active until deleted by the host (admin command).

The ring buffer may be further accelerated with Compute Express Link® (CXL®) caching (host-bias).

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claim

Embodiments of the disclosure may extend to the following statements, without limitation:

Statement 1. An embodiment of the inventive concept includes a system, comprising:
a processor;
a device;
a memory accessible to the processor and to the device, the memory including a queue including an entry and a buffer, the buffer identified by the entry;
wherein the processor is configured to place a request in the entry of the queue and the device is configured to process the request using the buffer.

Statement 2. An embodiment of the inventive concept includes the system according to statement 1, wherein the device includes a storage device.

Statement 3. An embodiment of the inventive concept includes the system according to statement 2, wherein the request includes a read request or a write request.

Statement 4. An embodiment of the inventive concept includes the system according to statement 1, wherein the device supports a Non-Volatile Memory Express (NVMe) protocol.

Statement 5. An embodiment of the inventive concept includes the system according to statement 1, wherein the device supports a Compute Express Link (CXL) protocol.

Statement 6. An embodiment of the inventive concept includes the system according to statement 1, wherein the memory is associated with the processor.

Statement 7. An embodiment of the inventive concept includes the system according to statement 1, wherein the memory is associated with the device.

Statement 8. An embodiment of the inventive concept includes the system according to statement 7, wherein the device includes the memory.

Statement 9. An embodiment of the inventive concept includes the system according to statement 1, wherein the queue includes a ring buffer, the ring buffer including a head pointer and a tail pointer.

Statement 10. An embodiment of the inventive concept includes the system according to statement 9, wherein the processor is configured to update the head pointer based at least in part on the processor placing the request in the entry of the queue.

Statement 11. An embodiment of the inventive concept includes the system according to statement 9, wherein the processor is configured to update the tail pointer based at least in part on the processor updating data in the entry of the queue.

Statement 12. An embodiment of the inventive concept includes the system according to statement 9, wherein the processor is configured to update the tail pointer based at least in part on the processor removing data from the entry of the queue.

Statement 13. An embodiment of the inventive concept includes the system according to statement 1, wherein:
the buffer includes a first size; and
the device includes a unit, the unit including a second size.

Statement 14. An embodiment of the inventive concept includes the system according to statement 13, wherein the first size is equal to the second size.

Statement 15. An embodiment of the inventive concept includes the system according to statement 13, wherein the second size is an integer multiple of the first size.

Statement 16. An embodiment of the inventive concept includes the system according to statement 13, wherein the first size is an integer multiple of the second size.

Statement 17. An embodiment of the inventive concept includes the system according to statement 1, wherein the request includes a control, a status, a buffer identifier (ID) for the buffer, a namespace ID (NSID), or an address associated with the device.

Statement 18. An embodiment of the inventive concept includes the system according to statement 1, wherein:
the queue includes a first number of entries;
the memory includes a second number of buffers; and
the first number of entries is equal to the second number of buffers.

Statement 19. An embodiment of the inventive concept includes the system according to statement 1, wherein the processor is configured to notify the device about the queue and the buffer.

Statement 20. An embodiment of the inventive concept includes the system according to statement 1, wherein the device includes a notification mechanism for the processor to notify the device that the request has been placed in the entry of the queue.

Statement 21. An embodiment of the inventive concept includes the system according to statement 20, wherein the notification mechanism includes a doorbell.

Statement 22. An embodiment of the inventive concept includes the system according to statement 21, wherein the doorbell is associated with a controller of the device.

Statement 23. An embodiment of the inventive concept includes the system according to statement 22, wherein the doorbell is associated with a function of the controller of the device.

Statement 24. An embodiment of the inventive concept includes the system according to statement 23, wherein the device includes a second doorbell associated with a second function of the controller of the device.

Statement 25. An embodiment of the inventive concept includes the system according to statement 22, wherein the device includes a second doorbell associated with a second controller of the device.

Statement 26. An embodiment of the inventive concept includes the system according to statement 1, wherein the device is configured to notify the processor when the request in the entry of the queue has been processed by the device.

Statement 27. An embodiment of the inventive concept includes the system according to statement 26, wherein the device is configured to send an interrupt to the processor when the request in the entry of the queue has been processed by the device.

Statement 28. An embodiment of the inventive concept includes the system according to statement 1, wherein the device is configured to update a status in the entry of the queue based at least in part on the device processing the request.

Statement 29. An embodiment of the inventive concept includes the system according to statement 1, wherein the processor is configured to deallocate the queue and the buffer.

Statement 30. An embodiment of the inventive concept includes the system according to statement 29, wherein the processor is further configured to notify the device that the queue and the buffer have been deallocated.

Statement 31. An embodiment of the inventive concept includes the system according to statement 1, wherein the device is configured to process the request in the entry of the queue and a second request in a second entry of the queue according to an interval.

Statement 32. An embodiment of the inventive concept includes the system according to statement 31, wherein the processor is configured to specify the interval to the device.

Statement 33. An embodiment of the inventive concept includes the system according to statement 1, wherein the buffer is subject to host bias mode.

Statement 34. An embodiment of the inventive concept includes a method, comprising:
placing, by a processor, a request in an entry of a queue in a memory;
associating, by the processor, the request in the entry of the queue with a buffer in the memory;
notifying a device, by the processor, that the request has been placed in the entry of the queue; and
retrieving, by the processor, a result of the request based at least in part on the entry of the queue and the buffer.

Statement 35. An embodiment of the inventive concept includes the method according to statement 34, wherein the device supports a Non-Volatile Memory Express (NVMe) protocol.

Statement 36. An embodiment of the inventive concept includes the method according to statement 34, wherein the device supports a Compute Express Link (CXL) protocol.

Statement 37. An embodiment of the inventive concept includes the method according to statement 34, wherein the queue includes a ring buffer.

Statement 38. An embodiment of the inventive concept includes the method according to statement 34, wherein placing, by the processor, the request in the entry of the queue in the memory includes updating a head pointer for the queue.

Statement 39. An embodiment of the inventive concept includes the method according to statement 34, wherein retrieving, by the processor, the result of the request based at least in part on the entry of the queue and the buffer includes receiving a notification from the device that the entry of the queue has been updated.

Statement 40. An embodiment of the inventive concept includes the method according to statement 39, wherein receiving the notification from the device that the entry of the queue has been updated includes receiving an interrupt from the device that the entry of the queue has been updated.

Statement 41. An embodiment of the inventive concept includes the method according to statement 34, wherein retrieving, by the processor, the result of the request based at least in part on the entry of the queue and the buffer includes updating a tail pointer for the queue.

Statement 42. An embodiment of the inventive concept includes the method according to statement 34, wherein the request includes a control, a status, a buffer identifier (ID) for the buffer, a namespace ID (NSID), or an address associated with the device.

Statement 43. An embodiment of the inventive concept includes the method according to statement 34, wherein the device includes a storage device.

Statement 44. An embodiment of the inventive concept includes the method according to statement 43, wherein:
the request includes a read request; and
retrieving, by the processor, the result of the request based at least in part on the entry of the queue and the buffer includes reading data from the buffer based at least in part on the storage device processing the request in the entry of the queue.

Statement 45. An embodiment of the inventive concept includes the method according to statement 43, wherein:
the request includes a write request; and
placing, by the processor, the request in the entry of the queue in the memory includes storing data in the buffer based at least in part on the request in the entry of the queue.

Statement 46. An embodiment of the inventive concept includes the method according to statement 34, wherein the memory is associated with the processor.

Statement 47. An embodiment of the inventive concept includes the method according to statement 34, wherein the memory is associated with the device.

Statement 48. An embodiment of the inventive concept includes the method according to statement 47, wherein the device includes the memory.

Statement 49. An embodiment of the inventive concept includes the method according to statement 34, further comprising:
allocating, by the processor, the queue in the memory; and
allocating, by the processor, the buffer in the memory.

Statement 50. An embodiment of the inventive concept includes the method according to statement 49, wherein:
allocating, by the processor, the queue in the memory includes:
   allocating, by the processor, the entry of the queue in the memory; and
   allocating, by the processor, a second entry of the queue in the memory; and
allocating, by the processor, the buffer in the memory includes:
   allocating, by the processor, the buffer in the memory; and
   allocating, by the processor, a second buffer in the memory.

Statement 51. An embodiment of the inventive concept includes the method according to statement 49, further comprising notifying the device, by the processor, about the queue and the buffer.

Statement 52. An embodiment of the inventive concept includes the method according to statement 51, wherein notifying the device, by the processor, about the queue and the buffer includes:
notifying the device, by the processor, about a first base address of the queue, a size of the entry, and a number of entries in the queue; and
notifying the device, by the processor, about a second base address of the buffer and a size of the buffer.

Statement 53. An embodiment of the inventive concept includes the method according to statement 34, further comprising:
deallocating, by the processor, the queue in the memory; and
deallocating, by the processor, the buffer in the memory.

Statement 54. An embodiment of the inventive concept includes the method according to statement 34, wherein the processor is configured to place the request in the entry of the queue and a second request in a second entry of the queue according to an interval.

Statement 55. An embodiment of the inventive concept includes the method according to statement 54, further comprising notifying the device, by the processor, of the interval.

Statement 56. An embodiment of the inventive concept includes a method, comprising:
receiving, from a processor at a device, a notification that a request has been placed in an entry of a queue in a memory;
accessing, by the device, the request from the entry of the queue in the memory; and
processing, by the device, the request using at least one of the device and a buffer in the memory.

Statement 57. An embodiment of the inventive concept includes the method according to statement 56, wherein the device supports a Non-Volatile Memory Express (NVMe) protocol.

Statement 58. An embodiment of the inventive concept includes the method according to statement 56, wherein the device supports a Compute Express Link (CXL) protocol.

Statement 59. An embodiment of the inventive concept includes the method according to statement 56, wherein the queue includes a ring buffer.

Statement 60. An embodiment of the inventive concept includes the method according to statement 56, wherein the memory is associated with the processor.

Statement 61. An embodiment of the inventive concept includes the method according to statement 56, wherein the memory is associated with the device.

Statement 62. An embodiment of the inventive concept includes the method according to statement 61, wherein the device includes the memory.

Statement 63. An embodiment of the inventive concept includes the method according to statement 56, further comprising notifying the processor, by the device, that the request has been processed.

Statement 64. An embodiment of the inventive concept includes the method according to statement 63, wherein notifying the processor, by the device, that the request has been processed includes updating a status in the entry of the queue.

Statement 65. An embodiment of the inventive concept includes the method according to statement 63, wherein notifying the processor, by the device, that the request has been processed includes sending, by the device, an interrupt to the processor.

Statement 66. An embodiment of the inventive concept includes the method according to statement 56, wherein the request includes a control, a status, a buffer identifier (ID) for the buffer, a namespace ID (NSID), or an address associated with the device.

Statement 67. An embodiment of the inventive concept includes the method according to statement 66, wherein processing, by the device, the request using at least one of the device and the buffer in the memory includes identifying the buffer based at least in part on the buffer ID in the request in the entry of the queue.

Statement 68. An embodiment of the inventive concept includes the method according to statement 67, wherein processing, by the device, the request using at least one of the device and the buffer in the memory further includes determining an address for the buffer based at least in part on the buffer ID and a base address for the buffer.

Statement 69. An embodiment of the inventive concept includes the method according to statement 56, wherein the device includes a storage device.

Statement 70. An embodiment of the inventive concept includes the method according to statement 69, wherein:
the request includes a read request; and
processing, by the device, the request using at least one of the device and the buffer in the memory includes:
   reading a data from the storage device based at least in part on the request; and
   storing the data in the buffer.

Statement 71. An embodiment of the inventive concept includes the method according to statement 69, wherein:
the request includes a write request; and
processing, by the device, the request using at least one of the device and the buffer in the memory includes:
   reading a data from the buffer; and
   storing the data in the storage device based at least in part on the request.

Statement 72. An embodiment of the inventive concept includes the method according to statement 56, wherein the device is configured to process the request in the entry of the queue and a second request in a second entry of the queue according to an interval.

Statement 73. An embodiment of the inventive concept includes the method according to statement 72, further comprising receiving, at the device, from the processor the interval.

Statement 74. An embodiment of the inventive concept includes a system, comprising a non-transitory storage medium, the non-transitory storage medium having stored thereon instructions that, when executed by a machine, result in:
placing, by a processor, a request in an entry of a queue in a memory;
associating, by the processor, the request in the entry of the queue with a buffer in the memory;
notifying a device, by the processor, that the request has been placed in the entry of the queue; and
retrieving, by the processor, a result of the request based at least in part on the entry of the queue and the buffer.

Statement 75. An embodiment of the inventive concept includes the system according to statement 74, wherein the device supports a Non-Volatile Memory Express (NVMe) protocol.

Statement 76. An embodiment of the inventive concept includes the system according to statement 74, wherein the device supports a Compute Express Link (CXL) protocol.

Statement 77. An embodiment of the inventive concept includes the system according to statement 74, wherein the queue includes a ring buffer.

Statement 78. An embodiment of the inventive concept includes the system according to statement 74, wherein placing, by the processor, the request in the entry of the queue in the memory includes updating a head pointer for the queue.

Statement 79. An embodiment of the inventive concept includes the system according to statement 74, wherein retrieving, by the processor, the result of the request based at least in part on the entry of the queue and the buffer includes receiving a notification from the device that the entry of the queue has been updated.

Statement 80. An embodiment of the inventive concept includes the system according to statement 79, wherein receiving the notification from the device that the entry of the queue has been updated includes receiving an interrupt from the device that the entry of the queue has been updated.

Statement 81. An embodiment of the inventive concept includes the system according to statement 74, wherein retrieving, by the processor, the result of the request based at least in part on the entry of the queue and the buffer includes updating a tail pointer for the queue.

Statement 82. An embodiment of the inventive concept includes the system according to statement 74, wherein the request includes a control, a status, a buffer identifier (ID) for the buffer, a namespace ID (NSID), or an address associated with the device.

Statement 83. An embodiment of the inventive concept includes the system according to statement 74, wherein the device includes a storage device.

Statement 84. An embodiment of the inventive concept includes the system according to statement 83, wherein:
the request includes a read request; and
retrieving, by the processor, the result of the request based at least in part on the entry of the queue and the buffer includes reading data from the buffer based at least in part on the storage device processing the request in the entry of the queue.

Statement 85. An embodiment of the inventive concept includes the system according to statement 83, wherein:
the request includes a write request; and
placing, by the processor, the request in the entry of the queue in the memory includes storing data in the buffer based at least in part on the request in the entry of the queue.

Statement 86. An embodiment of the inventive concept includes the system according to statement 74, wherein the memory is associated with the processor.

Statement 87. An embodiment of the inventive concept includes the system according to statement 74, wherein the memory is associated with the device.

Statement 88. An embodiment of the inventive concept includes the system according to statement 87, wherein the device includes the memory.

Statement 89. An embodiment of the inventive concept includes the system according to statement 74, the non-transitory storage medium having stored thereon further instructions that, when executed by the machine, result in:
allocating, by the processor, the queue in the memory; and
allocating, by the processor, the buffer in the memory.

Statement 90. An embodiment of the inventive concept includes the system according to statement 89, wherein:
allocating, by the processor, the queue in the memory includes:
   allocating, by the processor, the entry of the queue in the memory; and
   allocating, by the processor, a second entry of the queue in the memory; and
allocating, by the processor, the buffer in the memory includes:
   allocating, by the processor, the buffer in the memory; and
   allocating, by the processor, a second buffer in the memory.

Statement 91. An embodiment of the inventive concept includes the system according to statement 89, the non-transitory storage medium having stored thereon further instructions that, when executed by the machine, result in notifying the device, by the processor, about the queue and the buffer.

Statement 92. An embodiment of the inventive concept includes the system according to statement 91, wherein notifying the device, by the processor, about the queue and the buffer includes:
notifying the device, by the processor, about a first base address of the queue, a size of the entry, and a number of entries in the queue; and
notifying the device, by the processor, about a second base address of the buffer and a size of the buffer.

Statement 93. An embodiment of the inventive concept includes the system according to statement 74, the non-transitory storage medium having stored thereon further instructions that, when executed by the machine, result in:
deallocating, by the processor, the queue in the memory; and
deallocating, by the processor, the buffer in the memory.

Statement 94. An embodiment of the inventive concept includes the system according to statement 74, wherein the processor is configured to place the request in the entry of the queue and a second request in a second entry of the queue according to an interval.

Statement 95. An embodiment of the inventive concept includes the system according to statement 94, the non-transitory storage medium having stored thereon further instructions that, when executed by the machine, result in notifying the device, by the processor, of the interval.

Statement 96. An embodiment of the inventive concept includes a system, comprising a non-transitory storage medium, the non-transitory storage medium having stored thereon instructions that, when executed by a machine, result in:
receiving, from a processor at a device, a notification that a request has been placed in an entry of a queue in a memory;
accessing, by the device, the request from the entry of the queue in the memory; and
processing, by the device, the request using at least one of the device and a buffer in the memory.

Statement 97. An embodiment of the inventive concept includes the system according to statement 96, wherein the device supports a Non-Volatile Memory Express (NVMe) protocol.

Statement 98. An embodiment of the inventive concept includes the system according to statement 96, wherein the device supports a Compute Express Link (CXL) protocol.

Statement 99. An embodiment of the inventive concept includes the system according to statement 96, wherein the queue includes a ring buffer.

Statement 100. An embodiment of the inventive concept includes the system according to statement 96, wherein the memory is associated with the processor.

Statement 101. An embodiment of the inventive concept includes the system according to statement 96, wherein the memory is associated with the device.

Statement 102. An embodiment of the inventive concept includes the system according to statement 101, wherein the device includes the memory.

Statement 103. An embodiment of the inventive concept includes the system according to statement 96, the non-transitory storage medium having stored thereon further instructions that, when executed by the machine, result in notifying the processor, by the device, that the request has been processed.

Statement 104. An embodiment of the inventive concept includes the system according to statement 103, wherein notifying the processor, by the device, that the request has been processed includes updating a status in the entry of the queue.

Statement 105. An embodiment of the inventive concept includes the system according to statement 103, wherein notifying the processor, by the device, that the request has been processed includes sending, by the device, an interrupt to the processor.

Statement 106. An embodiment of the inventive concept includes the system according to statement 96, wherein the request includes a control, a status, a buffer identifier (ID) for the buffer, a namespace ID (NSID), or an address associated with the device.

Statement 107. An embodiment of the inventive concept includes the system according to statement 106, wherein processing, by the device, the request using at least one of the device and the buffer in the memory includes identifying the buffer based at least in part on the buffer ID in the request in the entry of the queue.

Statement 108. An embodiment of the inventive concept includes the system according to statement 107, wherein processing, by the device, the request using at least one of the device and the buffer in the memory further includes determining an address for the buffer based at least in part on the buffer ID and a base address for the buffer.

Statement 109. An embodiment of the inventive concept includes the system according to statement 96, wherein the device includes a storage device.

Statement 110. An embodiment of the inventive concept includes the system according to statement 109, wherein:
the request includes a read request; and
processing, by the device, the request using at least one of the device and the buffer in the memory includes:
   reading a data from the storage device based at least in part on the request; and
   storing the data in the buffer.

Statement 111. An embodiment of the inventive concept includes the system according to statement 109, wherein:
the request includes a write request; and
processing, by the device, the request using at least one of the device and the buffer in the memory includes:
   reading a data from the buffer; and
   storing the data in the storage device based at least in part on the request.

Statement 112. An embodiment of the inventive concept includes the system according to statement 96, wherein the device is configured to process the request in the entry of the queue and a second request in a second entry of the queue according to an interval.

Statement 113. An embodiment of the inventive concept includes the system according to statement 112, the non-transitory storage medium having stored thereon further instructions that, when executed by the machine, result in receiving, at the device, from the processor the interval.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A system, comprising:
a processor;
a device;
a memory accessible to the processor and to the device, the memory including a queue including an entry and a buffer, the buffer identified by the entry;
wherein the processor is configured to place a request in the entry of the queue and the device is configured to process the request using the buffer.

2. The system according to claim 1, wherein the device includes a storage device.

3. The system according to claim 1, wherein the device supports a Non-Volatile Memory Express (NVMe) protocol.

4. The system according to claim 1, wherein the queue includes a ring buffer, the ring buffer including a head pointer and a tail pointer.

5. The system according to claim 1, wherein:
the buffer includes a first size; and
the device includes a unit, the unit including a second size.

6. The system according to claim 5, wherein the first size is equal to the second size.

7. The system according to claim 5, wherein the second size is an integer multiple of the first size.

8. The system according to claim 1, wherein the request includes a control, a status, a buffer identifier (ID) for the buffer, a namespace ID (NSID), or an address associated with the device.

9. The system according to claim 1, wherein:
the queue includes a first number of entries;
the memory includes a second number of buffers; and
the first number of entries is equal to the second number of buffers.

10. The system according to claim 1, wherein the device includes a notification mechanism for the processor to notify the device that the request has been placed in the entry of the queue.

11. A method, comprising:
placing, by a processor, a request in an entry of a queue in a memory;
associating, by the processor, the request in the entry of the queue with a buffer in the memory;
notifying a device, by the processor, that the request has been placed in the entry of the queue; and
retrieving, by the processor, a result of the request based at least in part on the entry of the queue and the buffer.

12. The method according to claim 11, wherein:
the device includes a storage device;
the request includes a read request; and
retrieving, by the processor, the result of the request based at least in part on the entry of the queue and the buffer includes reading data from the buffer based at least in part on the storage device processing the request in the entry of the queue.

13. The method according to claim 11, further comprising:
allocating, by the processor, the queue in the memory; and
allocating, by the processor, the buffer in the memory.

14. The method according to claim 13, further comprising notifying the device, by the processor, about the queue and the buffer.

15. The method according to claim 11, further comprising notifying the device, by the processor, of an interval.

16. A method, comprising:
receiving, from a processor at a device, a notification that a request has been placed in an entry of a queue in a memory;
accessing, by the device, the request from the entry of the queue in the memory; and
processing, by the device, the request using at least one of the device and a buffer in the memory.

17. The method according to claim 16, further comprising updating a status in the entry of the queue.

18. The method according to claim 16, wherein processing, by the device, the request using at least one of the device and the buffer in the memory includes identifying the buffer based at least in part on a buffer ID in the request in the entry of the queue.

19. The method according to claim 16, wherein:
the device includes a storage device;
the request includes a read request; and
processing, by the device, the request using at least one of the device and the buffer in the memory includes:
reading a data from the storage device based at least in part on the request; and
storing the data in the buffer.

20. The method according to claim 16, wherein the device is configured to process the request in the entry of the queue and a second request in a second entry of the queue according to an interval.
